(19) United States
(12) Patent Application Publication
(10) Pub. No.: US 2025/0100508 A1
(43) Pub. Date: Mar. 27, 2025

(54) METHOD FOR ACTUATING AN ACCESS SYSTEM OF A MOTOR VEHICLE

(71) Applicant: MERCEDES-BENZ GROUP AG, Stuttgart (DE)

(72) Inventor: Özgür MUTLU, Stuttgart (DE)

(21) Appl. No.: 18/832,731

(22) PCT Filed: Dec. 5, 2022
(86) PCT No.: PCT/EP2022/084382

§ 371 Date: Jul. 24, 2024

(30) Foreign Application Priority Data
Jan. 25, 2022 (DE) 10 2022 000 262.0

(51) Int. Cl. B60R 25/24; B60R 25/31

(52) U.S. Cl. CPC B60R 25/245; B60R 25/31; B60R 2325/10

(57) ABSTRACT

A method for actuating an access system of a motor vehicle uses an ultra-wideband (UWB) unit operated in a radar mode to detect a position of a person approaching the motor vehicle and perform a body position scan of the person in order to detect a body position of the person. An orientation of the face of the person and/or a line of sight of the person is determined by the UWB unit. The access system is actuated when this person looks in the direction of a vehicle door of the motor vehicle.

### BACKGROUND AND SUMMARY OF THE INVENTION

Exemplary embodiments of the invention relate to a method for actuating an access system of a motor vehicle.

A method of the generic type mentioned above is known from CN 210466502 U. It uses an ultra-wideband unit in order to detect the approach of a person to a vehicle and to detect the position of the person in front of the vehicle door. Furthermore, when the person has approached the vehicle close enough, the line of sight of the person is detected and evaluated by means of a camera, wherein an access system of the motor vehicle is actuated when the person looks towards the vehicle door. A disadvantage of this is that the motor vehicle must be equipped with relatively many, expensive sensors to realize the method, such that the implementation of this method in a motor vehicle is associated with relatively high costs.

An ultra-wideband unit is known from CN 111616715 A which includes a body scanner and is set up to detect the orientation of a person, in particular the orientation of the face of the person.

Exemplary embodiments of the invention are directed to a method that is improved in relation to the known method.

According to embodiments there is a method for actuating an access system of a motor vehicle is proposed according to the invention, wherein the motor vehicle is initially equipped with an access system for locking and unlocking the same and an ultra-wideband unit, referred to as a UWB unit in the following. The UWB unit is set up to be operated as a UWB radar in a radar mode. It is essential for the method that the UWB unit is operated in the radar mode and that it detects the position of a person approaching the motor vehicle and simultaneously carries out a body position scan of this person in order to detect the body position of this person. In the process, in particular, an orientation of the face or head of this person and/or a line of sight of the face or head of this person can be detected. The access system of the motor vehicle is then actuated according to the invention exactly when the person, in particular the head of the same, looks in the direction of a vehicle door of the motor vehicle and/or when the person is located within a specified distance of the vehicle. Therefore, it is possible to either approve or deny a person access to the motor vehicle depending on their body position and position relative to the said motor vehicle. In particular, it is also advantageous that determining the position of a person approaching the motor vehicle can only be realized by means of the UWB unit and that additional sensors on the motor vehicle, in particular cameras for facial recognition, can be dispensed with. Therefore, the method according to the invention can be realized with relatively few components and thus can be implemented relatively cost-effectively in motor vehicles.

In particular, the invention can also involve providing a motor vehicle in which the method described above is implemented. Expediently, the motor vehicle is set up to carry out the implemented method, for example by means of a control device installed in the motor vehicle.

To summarize, the following should be noted: The invention expediently relates to a method for actuating an access system of a motor vehicle, which is equipped with an access system for locking and unlocking the motor vehicle and an ultra-wideband unit referred to as a UWB unit in the following. The UWB unit is set up to be operated in a radar mode. It is essential for the method that the UWB unit is operated in the radar mode and detects a position of a person approaching the motor vehicle and carries out a body position scan of this person in order to detect a body position of this person; in the process, in particular, an orientation of the face of this person and/or a line of sight of this person can be determined by the UWB unit. The access system is actuated according to the invention exactly when this person looks in the direction of a vehicle door of the motor vehicle.

Further important features and advantages of the invention result from the dependent claims, the drawing and the associated figure description based on the drawing.

It is understood that the aforementioned features and the features still to be explained in the following can not only be used in the respectively specified combination, but also in other combinations or in isolation, without leaving the scope of the present invention.

Preferred exemplary embodiments of the invention are shown in the drawings and are explained in more detail in the following description, wherein the same reference signs refer to identical or similar or functionally identical components.

### BRIEF DESCRIPTION OF THE DRAWING FIGURES

In the drawing:

FIG. 1 schematically shows a perspective view of an arbitrary motor vehicle having a UWB unit according to a first embodiment when the method according to the invention is being carried out,

FIG. 2 schematically shows a plan view of an arbitrary motor vehicle having a UWB unit according to a further embodiment when the method according to the invention is being carried out,

FIG. 3 schematically shows a flow chart of the method according to the invention,

FIG. 4 schematically shows a plan view of a section of a motor vehicle.

### DETAILED DESCRIPTION

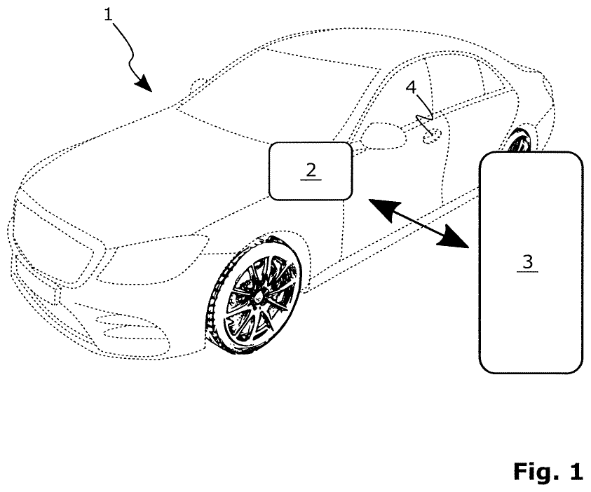

FIG. 1 shows an arbitrary, commercially available motor vehicle, referred to as a whole with reference numeral 1, which is equipped with a central UWB unit 2 (symbolized here by a simple box) according to a first embodiment and an access system 4 for locking and unlocking the motor vehicle 1. A person 3, also symbolized by a simple box, approaches the motor vehicle 1, wherein the UWB unit 2 carries out the method according to the invention, in which it is operated in a radar mode so that it continuously detects a position of the person 3 approaching the motor vehicle 1 and their body position. The access system 4 is actuated when the person 3 looks, in particular with their head, in the direction of a vehicle door of the motor vehicle 1 and/or is located within a specified distance of the motor vehicle 1. The UWB unit 2 and the access system 4 can communicate with each other, for example, via a control device of the motor vehicle 1 (not shown) and are controlled by the same.

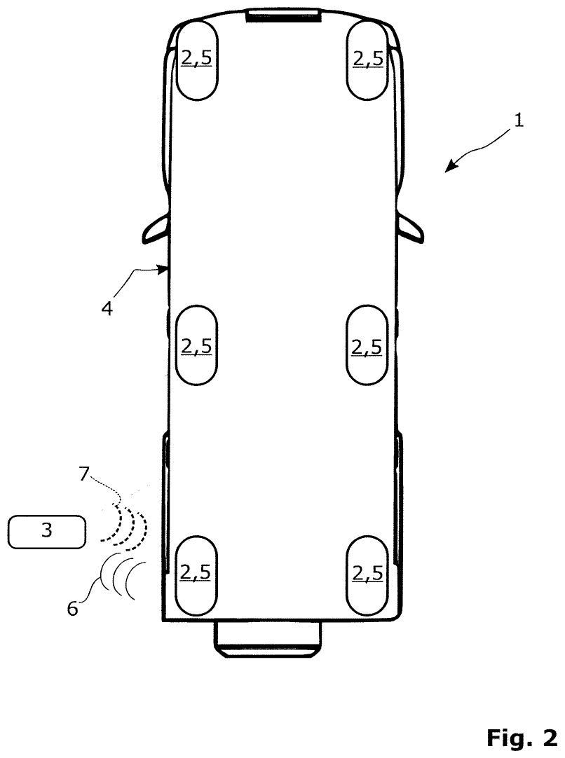

FIG. 2 shows a further arbitrary motor vehicle 1 having a UWB unit 2 according to a further embodiment. In comparison to the preceding UWB unit 2, the present UWB unit 2 has six separate UWB modules 5, indicated by boxes, which are each set up to carry out the method according to the invention. The UWB modules 5 are in particular set up to communicate via a UWB communication with a mobile end device carried by a person 3 authorized to use the motor vehicle 1 which, for example, can be realized by a so-called intelligent key (smart key) or a mobile phone (smart phone) or a so-called CoD, i.e., a smart device in the possession of the user of the motor vehicle (consumer owned smart device). Expediently, the UWB modules 5 are set up to determine the position of the mobile end device or of the person 3 relative to the motor vehicle 1 as part of the UWB communication with the mobile end device of the said person 3.

This UWB communication can be designed according to the guidelines of the car connectivity consortium (CCC).

Further expediently, the UWB modules 5 of the UWB unit 2 are set up to be operated in a radar mode, wherein, in particular, computer chips of the UWB modules 5 are set up for such a radar mode in terms of wireless technology. In radar mode, the respective UWB modules 5 of the UWB unit 2 emit relatively short radio signals 6 (symbolized in FIG. 2 by an undulating line) in the UWB radio frequency spectrum, lasting in particular a few nanoseconds, in order to sense the environment surrounding the motor vehicle 1. For example, the UWB modules 5 can each be equipped with a dedicated transmission device 8 set up for this purpose. In particular, it can also be provided that the UWB modules 5 of the UWB unit 2 function with pulsed radio signals, i.e., can be operated in a pulsed radar mode. Furthermore, in radar mode it is provided that each UWB module 5 of the UWB unit 2 functions as a receiver and detects backscattered echo radio signals 7, symbolized by undulating dashed lines in FIG. 2, of the emitted radio signals. For example, the UWB modules 5 can each have a dedicated receiving device 9 set up for this purpose. Therefore, it is possible by means of the UWB modules 5 of the UWB unit 2 to detect a position of a person 3 approaching the motor vehicle 1 and/or the body position of the person 3 relatively precisely. Depending on the detected position and/or body position of this person 3, in particular the line of sight 14 of the person 3, for example the access system 4 of the motor vehicle 1 can then be actuated, so that the person 3 is granted access to the motor vehicle 1 when they are orientated towards the motor vehicle and/or are looking towards the same. The UWB modules 5 of the UWB unit 2, which in particular realize a pulsed radar, also expediently comprise an internal system clock 10 and/or a pulse wave generator 11 and/or a radio signal amplifier and/or a wave delay detector 12 and/or a device 13 for classification of the orientation, in addition to the said components.

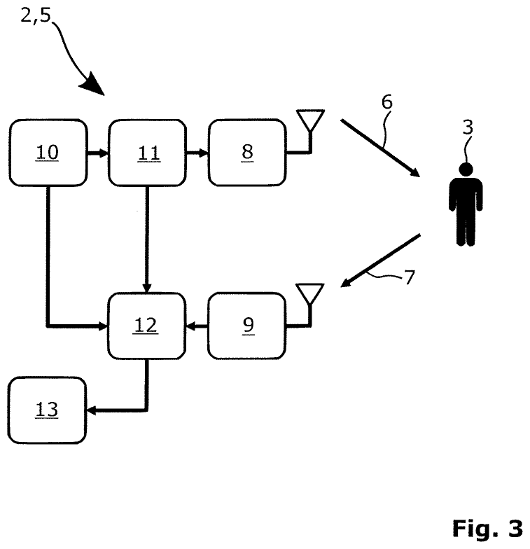

FIG. 3 shows an optional flow chart of the method according to the invention. It shows the UWB unit 2 or a UWB module 5 set up for a radar mode. The UWB unit 2/the UWB module 5 has a transmission device 8 and a receiving device 9, indicated by boxes. The transmission device 8 is supplied with an electrical control signal by an internal system clock 10 and a pulse wave generator 11, so that it can emit a radio signal 6 symbolized by an arrow, which is reflected back from a person 3 as an echo radio signal 7 with a time delay. The receiving device 9 detects the echo radio signal 7 and provides an electrical signal based thereon to a wave delay detector 12, which communicates with a device 13 for classification of the orientation of the person 3, so that an evaluation of the received echo signal 7 can be performed.

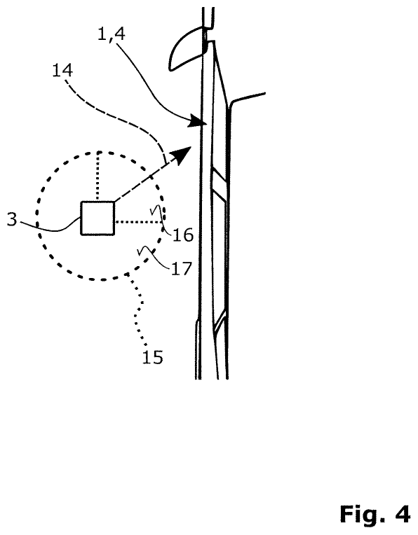

Lastly, FIG. 4 shows a section of a motor vehicle 1 which is equipped with a UWB unit 2 and/or UWB modules 5 (not shown) and is set up to carry out the method according to the invention. It is essential, in particular, that by means of UWB unit 2 and/or UWB modules 5 operated in radar mode, a position and/or a body position and/or a line of sight 14 of the person 3 is detected. In order to ensure that the person 3 is only then granted access to the motor vehicle 1 when they are actually orientated towards the motor vehicle 1 and/or are looking towards the same, it is expediently provided that in the scope of the method according to the invention, a classification circle 15 is provided for classification of the determined body position and/or line of sight 14 of the person 3. As long as the determined body position and/or line of sight 14 of the person 3 is within a first classification circle section 16 of the classification circle 15, it can be concluded with relatively high certainty that the person 3 actually seeks access to the motor vehicle 1, so that when the determined body position and/or line of sight 14 of the person 3 are actually within the first classification circle section 16 of the classification circle 15, the access system 4 of the motor vehicle 1 is actuated in order to allow the person 3 access. If instead the determined body position and/or line of sight 14 of the person 3 is within a second classification circle section 17 of the classification circle 15, designed as an example to complement the first classification circle section 16, it can conversely be concluded with relatively high certainty that the person 3 does not actually seek access to the motor vehicle 1, so that when the determined body position and/or line of sight 14 of the person 3 are within the second classification circle section 17 of the classification circle 15, the access system 4 of the motor vehicle 1 is not actuated and access to the motor vehicle 1 is blocked.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-3. (canceled)

4. A method for actuating an access system of a motor vehicle, wherein the motor vehicle includes the access system and the access system locks and unlocks the motor vehicle, the method comprising:
operating, an ultra-wideband unit of the motor vehicle, in radar mode;
detecting, by the ultra-wideband unit, a position of a person approaching the motor vehicle;
detecting, by the ultra-wideband unit, a body position of the person; and
actuating the access system when the person looks in a direction of a vehicle door of the motor vehicle or the person is located within a specified distance of the motor vehicle.

5. The method of claim 4, wherein the body position of the person is detected by a body position scan by the ultra-wideband unit operating in the radar mode.

6. The method of claim 5, wherein, while operating the ultra-wideband unit in the radar mode the method further comprising:
determining an orientation of a face of the person as part of the detecting the body position of the person, or
determining a line of sight of the person as part of the detecting the body position of the person.
